(19) United States
(12) Patent Application Publication
(10) Pub. No.: US 2016/0190808 A1
(43) Pub. Date: Jun. 30, 2016

(54) METHOD AND SYSTEM FOR MANAGING ELECTRIC POWER

(71) Applicant: LG CNS CO., LTD., Seoul (KR)

(72) Inventors: Jeong Hwan LEE, Seoul (KR); Gun Dong PARK, Seoul (KR); Hyunah LEE, Seoul (KR)

(73) Assignee: LG CNS CO., LTD., Seoul (KR)

(21) Appl. No.: 14/585,052

(22) Filed: Dec. 29, 2014

(51) Int. Cl. H02J 3/38

(52) U.S. Cl. CPC H02J 3/381

(57) ABSTRACT

An electric power management method of an electric power management device includes controlling a first power generator to operate according to a preset operating plan, calculating an available amount of stored power by subtracting a required amount of emergency power from an amount of electric power stored in an energy storage system when a power generation amount of the first power generator is less than an electric power use amount of a plurality of electric power use devices, controlling a second power to operate when a sum of the power generation amount of the first power generator and the amount of electrical power stored in the energy management system is less than the electric power use amount, and interrupting electric power of the electric power use devices in ascending order of priority.

### FIELD OF THE INVENTION

The present invention is related to a method and system for managing electric power, and more specifically, to a method and system for managing a supply of electric power by controlling a power generator to operate and stop according to power generation efficiency and power generation cost and for interrupting electric power according to an ascending order of priority.

### DISCUSSION OF RELATED ART

Recently, the interest in a stable electric power supply has in response to the frequent occurrence of power failures due to the rapid increase of electricity use. However, a problem occurs when a power supply for important buildings such as hospitals, is also be stopped when a power supply is stopped regardless of a degree of importance of devices that use electric power from the power supply. On the other hand, resources (for example, hydropower, thermal power, nuclear power, wind power, tidal power, solar power, geothermal power, and the like) for use in power generators to provide a consistent power supply are being diversified and the number of power generators is increasing.

A problem exists when power generation efficiency is degraded because operations of a plurality of power generators are managed without considering power generation efficiency and increased power generation cost. Accordingly, there is a need for efficiently operating a plurality of power generators while electric power is stably supplied to buildings having high priority and solutions to these problems are urgently needed.

The present invention is intended to solve the problems of the conventional technology and an object of the present invention is to provide a method and system for managing the supply of electric power by controlling a power generator to operate and stop according to power generation efficiency and power generation cost by interrupting electric power in an ascending order of priority. The object of the present invention is not limited to the problems previously described and other objects may be made apparent to those skilled in the art from the appended claims.

### SUMMARY OF THE INVENTION

In one aspect of the invention, a method of managing power devices is provided. The method includes operating a first power generator according to a predetermined operating plan, determining an amount of available stored power by subtracting a required amount of emergency power from a total amount of power stored in an energy storage system (ESS) when an amount of generated power of the first power generator is less than an amount of power required by a plurality of power use devices, operating a second power generator when a first sum of an amount of generated power of the first power generator and the determined amount of available stored power is less than the required amount of power and interrupting power provided to the at least one of the plurality of power use devices in ascending order of priority when a second sum of the amount of generated power of the first power generator and an amount of generated power of the second power generator is less than the required amount of power.

It is contemplated that the method further includes operating each of the first power generator, the second power generator, and a third power generator according to a corresponding determined power generation efficiency and determined power generation cost. It is further contemplated that the method further includes operating the third power generator when a third sum of the amount of generated power of the first power generator, the amount of generated power of the second power generator, and the determined amount of available stored power is less than the required amount of power.

It is contemplated that the method further includes stopping operation of the third power generator when the second sum is greater than the required amount of power. It is further contemplated that the method further includes predicting information related to at least weather, resource cost or power generation efficiency and revising the operating plan for each of a plurality of time zones according to the predicted information. It is further contemplated that the method further includes setting priorities of the plurality of power use devices according to a corresponding degree of importance and a corresponding degree of risk of power supply interruption.

It is contemplated that the method further includes storing excess power in the ESS when the amount of generated power of the first power generator is greater than the required amount of power. It is further contemplated that the method further includes supplying power stored in the ESS when the first sum is greater than the required amount of power. It is contemplated that the method further includes identifying power use devices to which power has been previously interrupted when the second sum is greater than the required amount of power and releasing the interruption of power to at least one of the identified power use devices in descending order of priority. Moreover, it is contemplated that the method further includes stopping operation of the second power generator if no power use devices are identified to which power has been previously interrupted.

In another aspect of the invention, a power management system is provided. The system includes a plurality of power generators configured to generate power, an energy storage system (ESS) configured to store power, a plurality of power use devices configured to use power, an ESS control unit configured to determine an amount of available stored power by subtracting a required amount of emergency power from a total amount of power stored in the ESS, a power generator operation control unit configured to operate a first power generator according to a predetermined operating plan, determine that an amount of generated power of the first power generator is less than an amount of power required by a plurality of power use devices and operate a second power generator when a first sum of an amount of generated power of the first power generator and the determined amount of available stored power is less than the required amount of power, and an electric power interruption control unit configured to interrupt power provided to at least one of the plurality of power use devices in ascending order of priority when a second sum of the amount of generated power of the first power generator and amount of generated power of the second power generator is less than the required amount of power use.

It is contemplated that the power generator operation control unit is further configured to operate each of the first power generator, the second power generator, and a third power generator according to a corresponding determined power generation efficiency and determined power generation cost. It is further contemplated that the power generator operation control unit is further configured to operate the third power generator when a third sum of the amount of generated power of the first power generator, the amount of generated power of the second power generator, and the determined amount of available stored power is less than the required amount of power.

It is contemplated that the power generator operation control unit is further configured to stop operation of the third power generator when the second sum is greater than the required amount of power. It is further contemplated that the method further includes an operating plan unit configured to predict information related to at least weather, resource cost or power generation efficiency and revise the operating plan for each of a plurality of time zones according to the predicted information.

It is contemplated that the electric power interruption control unit is further configured to set priorities of the plurality of power use devices according to a corresponding degree of importance and a corresponding degree of risk of power supply interruption. It is further contemplated that the ESS control unit is further configured to store excess power in the ESS when the amount of generated power of the first power generator is greater than the required amount of power.

It is contemplated that the ESS control unit is further configured to supply power stored in the ESS when the first sum is greater than the required amount of power. It is further contemplated that the electric power interruption control unit is further configured to identify devices to which power has been previously interrupted when the second sum is greater than the required amount of power use amount and release the interruption of power to at least one of the identified power use devices in descending order of priority. Moreover, it is contemplated that the power generator operation control unit is further configured to stop operation of the second power generator if no power use devices are identified to which power has been previously interrupted.

### BRIEF DESCRIPTION OF THE DRAWINGS

The objects, features and advantages of the present invention will become more apparent to those of ordinary skill in the art by describing in detail embodiments with reference to the accompanying drawings, in which:

FIG. 1 is a diagram illustrating a configuration of an electric power management system according to an embodiment of the present invention;

FIG. 2 is a diagram illustrating a configuration of an electric power management device according to an embodiment of the present invention; and

FIG. 3 is a flowchart illustrating a process for operating a power generator, stopping operation of the power generator, and releasing the interrupted electric power according to an embodiment of the present invention.

### DETAILED DESCRIPTION OF THE EMBODIMENTS

Embodiments of the present invention will be described in detail with reference to the attached drawings such that those skilled in the art can easily implement the present invention. The present invention may be embodied in various forms and is not limited to the described embodiments.

Furthermore, portions of the drawings not related to the present invention may be omitted to more clearly explain the present invention. Similar reference numerals are used throughout the different drawings to designate similar components. In the description of the present invention, detailed descriptions of incorporated known configurations and functions have been omitted when they may make the subject matter of the present invention unclear.

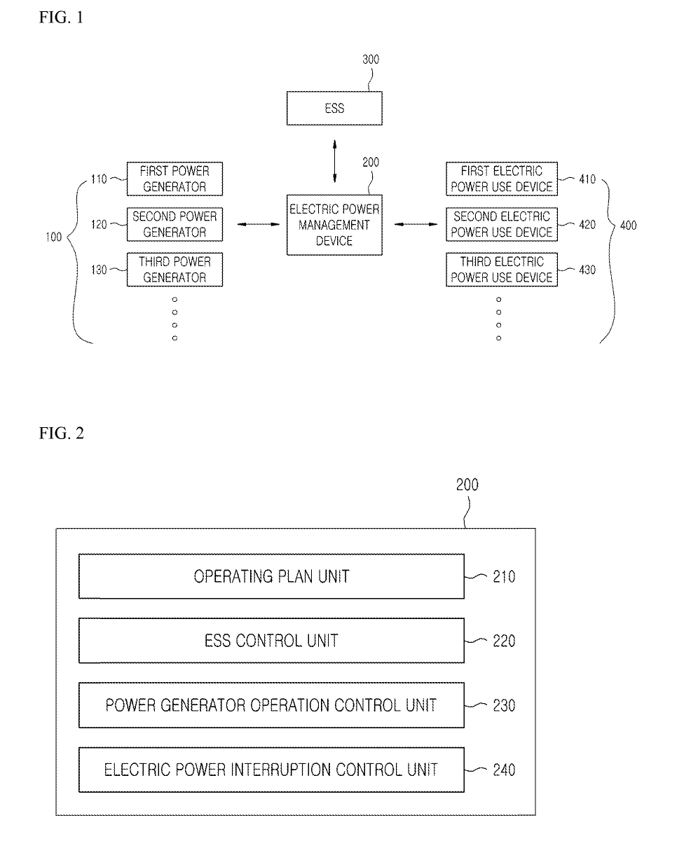

FIG. 1 is a diagram illustrating a configuration of an electric power management system according to an embodiment of the present invention. As illustrated in FIG. 1, the electric power management system includes a plurality of power generators 100, an electric power management device 200, an Energy Storage System (ESS) 300, and a plurality of electric power use devices 400.

The plurality of power generators 100 may include at least a first power generator 110, a second power generator 120, and a third power generator 130 that produce electric power. The plurality of power generators may include various power generators according to types of resources used for production of electric power.

The plurality of power generators 100 may include a hydropower generator, a thermal power generator, a nuclear power generator, a wind power generator, and the like. The plurality of power generators may be installed and distributed in places where power generators are required.

The electric power management device 200 may monitor an amount of electric power produced by each of the plurality of power generators 100. The plurality of power generators may be individually controlled to operate or stop.

The electric power management device 200 controls the storage and supply of electric power in the ESS 300. The electric power management device controls the supply of electric power produced by the plurality of power generators 100 and stored in the ESS to each of the plurality of electric power use devices 400.

The electric power management device 200 controls an interruption process of electric power that is supplied to one or more electric power use devices 400. The electric power management device also performs an electric power interruption release process to control the resumption of interrupted electric power to the one or more electric power use devices.

The ESS 300 is configured to store electrical energy. The ESS stores excessively produced electric power and supply the stored electric power when an electric power shortage occurs.

The ESS 300 may be implemented as one storage site or a plurality of storage sites. When the ESS is implemented as a plurality of storage sites, storage priority or supply priority may be set according to each storage site.

For example, the ESS 300 may include first, second, and third storage sites. The first, second, and third storage sites may have, respectively, first, second, and third storage priorities and complementary third, second, and first supply priorities.

The ESS 300 may store electric power first in the first storage site having the first storage priority when excessive electric power is produced and store the electric power in the second storage site having the second storage priority when the electric power stored in the first storage site is greater than or equal to a threshold value. The ESS may supply electric power first from power stored in the third storage site having the first supply priority when a shortage of electric power occurs and supply electric power stored in the second storage site having the second supply priority when the electric power stored in the third storage site is less than or equal to a threshold value.

The plurality of electric power use devices 400 includes at least a first electric power use device 410, a second electric power use device 420, and a third electric power use device 430. The plurality of electric power use devices use electric power supplied under control of the electric power management device 200 in order to perform a function defined according to each electric power use device.

The plurality of electric power use devices 400 may be distributed and installed in places in which electric power is used, for example, a house, a building, a factory, and the like. A priority is set according to each electric power use device.

For example, the first electric power use device 410 may be installed in a hospital building, the second electric power use device 420 may be installed in a factory, and the third electric power use device 430 may be installed in a house. The first electric power use device may have a first priority, the second electric power use device may have a second priority, and the third electric power use device may have the third priority according to a determined degree of importance of the electric power supply and degree of risk of interruption of electric power supply based on the locations where they are installed. The electric power management device 200 may control the supply of continuous electric power for an electric power use device having high priority by sequentially interrupting electric power in ascending order according to priorities set for each of the plurality of electric power use devices 400.

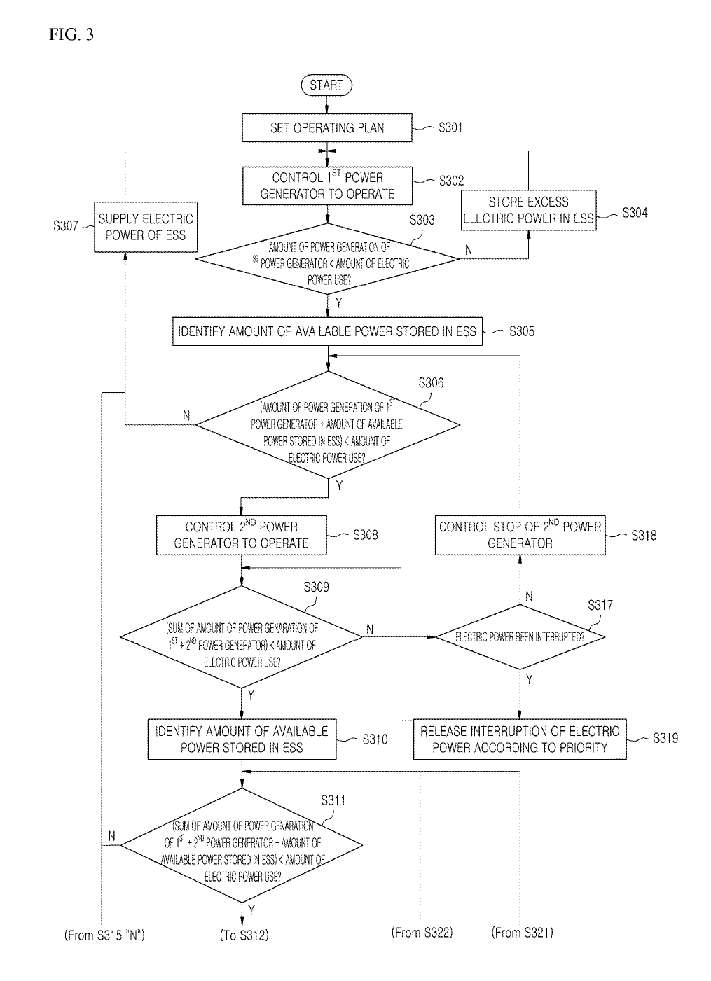

FIG. 2 is a diagram illustrating a configuration of the electric power management device 200 according to an embodiment of the present invention. As illustrated in FIG. 2, the electric power management device 200 includes an operating plan unit 210, an ESS control unit 220, a power generator operation control unit 230, and an electric power interruption control unit 240.

The operating plan unit 210 may predict weather, resource cost, power generation efficiency, and the like and set an operating plan based on the predicted information. For example, the operating plan unit may set an operating plan in which a solar power generator is operated when the weather is predicted to be sunny, set an operating plan in which a thermal power generator is operated when a coal resource cost is predicted to decrease, and set an operating plan in which the first power generator 110 is operated when the efficiency of the first power generator is predicted to increase.

The operating plan unit 210 may set the operating plan according to time zones. For example, when the efficiency of power generation for the first power generator 110 is predicted to be high from 01:00 PM to 03:00 PM and the efficiency of power generation for the second power generator 120 is predicted to be high from 03:00 PM to 05:00 PM, the operating plan unit may set an operating plan according to each time zone such that the first power generator is operated from 01:00 PM to 03:00 PM and the second power generator is operated from 03:00 PM to 05:00 PM.

The ESS control unit 220 controls the ESS 300 to store excess electric power when an amount power generation of the plurality of power generators 100 is greater than an amount of electric power use of the plurality of electric power use devices 400. For example, when the amount of power generation of the first power generator 110 is 1,000 kWh, the amount of electric power use of the first electric power use device 410 is 200 kWh, the amount of electric power use of the second electric power use device 420 is 300 kWh, and the amount of electric power use of the third electric power use device 430 is 400 kWh, the ESS control unit may control only the first power generator to operate and may control the ESS to store the remaining electric power of 100 kWh obtained by subtracting the 900 kWh total amount of electric power use from the 1,000 kWh amount of power generation.

The ESS control unit 220 may calculate an available amount of stored power by subtracting an amount of required emergency power from the total amount of electric power stored in the ESS 300. The amount of required emergency may refer to a minimum amount of electric power necessary for an emergency, such as a power failure, and the available amount of stored power may refer to an amount of electric power capable of being immediately supplied in excess of the amount of required emergency power. For example, when 500 kWh is stored in the ESS 300 and 50 kWh is set as the amount of required emergency power, the ESS control unit 220 may calculate 450 kWh as the available amount of stored power by subtracting 50 kWh from 500 kWh.

The ESS control unit 220 controls electric power stored in the ESS 300 to be supplied when a sum of the amount of power generation of the plurality of power generators 100 and the available amount of stored power is greater than the amount of electric power use of the plurality of electric power use devices 400. For example, when only the first power generator 110 operates with 900 kWh of power generation, the available amount of stored power is 200 kWh, and an amount of electric power use of the plurality of electric power use devices 400 is 1,000 kWh, the ESS control unit may control the supply of 100 kWh of electric power stored in the ESS.

The ESS control unit 220 accesses the electric power stored in the ESS 300 when the amount of power generation is less than an amount of electric power use in order to ensure sufficient supply of power. The ESS control unit controls electric power stored in the ESS to not be supplied when the total amount of electric power stored in the ESS is less than or equal to the required emergency power.

The power generator operation control unit 230 may select each of the first power generator 110, the second power generator 120, and the third power generator 130 according to power generation efficiency conditions, power generation cost, and the like related to each of the plurality of power generators 100. For example, the power generator operation control unit may compare power generation efficiencies and power generation costs when a nuclear power generator, a thermal power generator, a hydropower generator are included in the plurality of power generators 100 and select the nuclear power generator having highest power generation efficiency and lowest power generation cost as the first power generator, select the thermal power generator having second highest power generation efficiency and second lowest power generation cost as the second power generator, and select the hydropower generator as the third power generator.

The power generator operation control unit 230 may reselect each of the first power generator 110, the second power generator 120, and the third power generator 130 by comparing power generation efficiencies, power generation costs, and the like related to each of the plurality of power generators 100 according to time periods. For example, the power generator operation control unit 230 may reselect the hydropower generator that was previously selected for the third power generator as the first power generator 110 when the power generation efficiency of the hydropower generator increases as an amount of rainfall increases during the rainy season. Additionally, the power generator operation control unit may reselect the thermal power generator that was previously selected for the second power generator as the third power generator when the power generation cost for the thermal power generator increases due to increasing coal prices.

The power generator operation control unit 230 controls the operations of the plurality of power generators 100 according to an operating plan set by the operating plan unit 210.

The power generator operation control unit 230 may control only the first power generator 110 to be operated and later control the second power generator 120 to be operated when a sum of the amount of power generation of the first power generator and the available amount of stored power in the ESS 300 is less than the amount of electric power use of the plurality of electric power use devices 400. Additionally, the power generator operation control unit may control both the first power generator and second power generator to be operated and later may control the third power generator to be operated when a sum of the amount of power generation the first power generator and the available amount of stored power in the ESS is less than the amount of electric power use of the plurality of electric power use devices.

That is, the power generator operation control unit 230 may control the first power generator 110 to be operated first and the second power generator 120 may be controlled to operate when an amount of power supplied is insufficient due to a decrease in an amount of power generation of the first power generator or an increase in an amount of electric power use of the plurality of electric power use devices 400. Thereafter, the third power generator 130 may be controlled to operate when the amount of power supplied is insufficient.

The power generator operation control unit 230 may control the operation of the third power generator to be stopped when the first power generator 110, the second power generator 120, and the third power generator 130 are in operation and a sum of the amount of power generation of the first power generator and the second power generator is greater than the amount of electric power use of the plurality of electric power use devices 400. Thereafter, the power generator operation control unit may control the operation of the second power generator to be stopped when the amount of power generation of the first power generator is greater than the amount of electric power use of the plurality of electric power use devices.

The electric power interruption control unit 240 may compare the plurality of electric power use devices 400 according to a degree of importance of having electric power supplied, a degree of risk of interruption of the electric power supply, and the like, and set a priority for each of the plurality of electric power use devices. For example, the first electric power use device 410 installed in a hospital building may have the first priority, the second electric power use device 420 installed in a factory may have the second priority, and the third electric power use device 430 installed in a house may have the third priority according to a degree of importance of having electric power supplied, a degree of risk of interruption of the electric power supply, and the like.

The electric power interruption control unit 240 may interrupt electric power supplied to the plurality of electric power use devices 400 in ascending order of priority and the amount of electric power use of the plurality of electric power use devices may be reduced due to interruption of electric power when the amount of power generation of the plurality of power generators 100 is less than the amount of electric power use of the plurality of electric power use devices or, in other words, when the amount of electric power supply is insufficient. For example, the electric power interruption control unit 240 may first interrupt electric power supplied to the third electric power use device 430 having the third priority as the lowest priority when the electric power supply amount is insufficient. Thereafter, the electric power interruption control unit may interrupt electric power supplied to the second electric power use device 420 having the second priority when the electric power supply amount is still insufficient.

The electric power interruption control unit 240 may control the supply of electric power to be resumed by releasing the interruption of the supply of electric power in descending order of priority after identifying whether the supply of electric power to any of the plurality of electric power use devices 400 has been interrupted when the amount of power generation of the plurality of power generators 100 is greater than the amount of electric power use of the plurality of electric power use devices or, in other words, when there is an excess amount of electric power supply. For example, the electric power interruption control unit may first release the electric power interruption for the second electric power use device 420 having the second highest priority among electric power use devices when there is still an excess amount of electric power supply and the electric power supply for the second electric power use device and the third electric power use device 430 having the third highest priority among electric power use devices has been previously interrupted. Thereafter, the electric power interruption control unit may release the interruption of electric power for the third electric power use device having the third priority when there is still an excess amount of electric power supply.

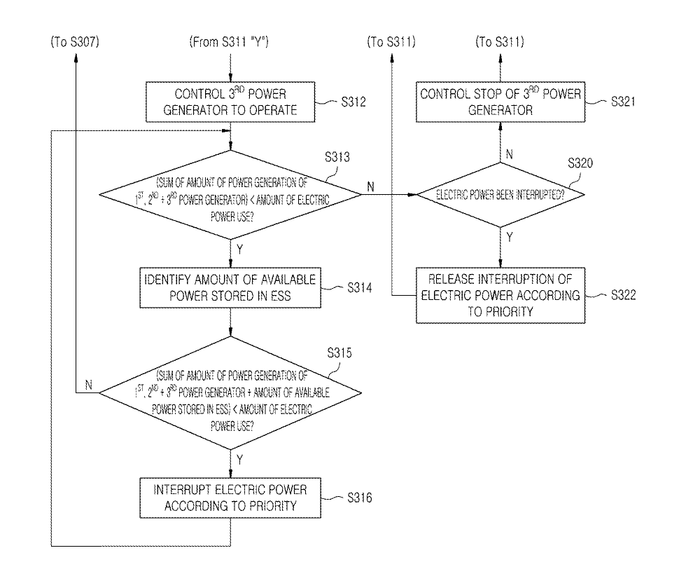

FIG. 3 is a flowchart illustrating a process for operating a power generator, stopping an operation of the power generator, and releasing electric power interruption according to an embodiment of the present invention.

The electric power management device 200 predicts at least weather, resource cost, power generation efficiency, and the like and sets an operating plan according to each time zone based on predicted information in step S301. The electric power management device selects each of the first power generator 110, the second power generator 120, and the third power generator 130 by comparing power generation efficiencies and power generation costs related to the plurality of power generators 100. Additionally, the electric power management device sets priorities of the first electric power use device 410, the second electric power use device 420, and the third electric power use device 430 by comparing degrees of importance of having electric power supplied, degrees of risk of interruption of the electric power supply, and the like for each of the plurality of electric power use devices 400.

The electric power management device 200 sets an operating plan in step S301 for every given period, reselects each of the first power generator 110, the second power generator 120, and the third power generator 130, and resets each of the priorities of the first electric power use device 410, the second electric power use device 420, and the third electric power use device 430. The electric power management device controls the first power generator to operate according to a previously set operating plan in step S302.

The electric power management device 200 compares the amount of power generation of the first power generator 110 to an amount of electric power use of the plurality of electric power use devices 400 in step S303. The comparison may be performed at a specific time interval.

The electric power management device 200 stores excess electric power in the ESS 300 in step S304 and then re-performs steps S302 and S303 when the comparison indicates that the amount of power generation of the first power generator 110 is greater than the amount of electric power use of the plurality of electric power use devices 400. In this way, the electric power management device stores excess generated electric power in the ESS during a period in which the amount of power generation of the first power generator is greater than the amount of electric power use of the plurality of electric power use devices.

The electric power management device 200 identifies an amount of available power stored in the ESS 300 in step S305 when the comparison of step S303 indicates that the amount of power generation of the first power generator 110 is less than the amount of electric power use of the plurality of electric power use devices 400 such as when the amount of electric power supply is insufficient due to a decrease in the amount of power generation of the first power generator 110 or an increase in the amount of electric power use of the plurality of electric power use devices. The electric power management device calculates the amount of available stored power in the ESS by subtracting an amount of required emergency power from a total amount of power stored in the ESS.

The electric power management device 200 compares a sum of the amount of power generation of the first power generator 110 and the amount of available power stored in the ESS 300 to the amount of electric power use of the plurality of electric power use devices 400 in step S306. The electric power management device supplies the electric power stored in the ESS in step S307 and then re-performs steps S302 and S303 when the comparison in step S306 indicates that the sum of the amount of power generation of the first power generator and the amount of available power stored in the ESS is greater than the amount of electric power use of the plurality of electric power use devices. In this way, the electric power management device addresses the insufficient supply of electric power by utilizing the available amount of stored power in the ESS without operating the second power generator.

The electric power management device 200 controls the operation of the second power generator 120 to operate in step S308 when the comparison in step S306 indicates that the sum of the amount of power generation of the first power generator 110 and the available amount of power stored in the ESS 300 is less than the amount of electric power use of the plurality of electric power use devices 400. In this way, the electric power management device addresses the insufficient supply of electric power by utilizing power generated by operating the second power generator.

The electric power management device 200 compares a sum of the amount of power generation of the first power generator 110 and the second power generator 120 to the amount of electric power use of the plurality of electric power use devices 400 in step S309. The electric power management device identifies an amount of available power stored in the ESS 300 in step S310 when the comparison of step S309 indicates that the sum of the amount of power generation of the first power generator and second power generator is less than the amount of electric power use of the plurality of electric power use devices such as when there is a decrease in the amount of power generation of the first power generator and second power generator or an increase in the amount of electric power use of the plurality of electric power use devices. The electric power management device calculates the amount of available stored power in the ESS by subtracting an amount of required emergency power from a total amount of power stored in the ESS.

The electric power management device 200 compares a sum of the amount of power generation of the first power generator 110 and second power generator 120 and the amount of available power stored in the ESS 300 to the amount of electric power use of the plurality of electric power use devices 400 in step S311. The electric power management device re-performs step S307 to supply the electric power stored in the ESS and then re-performs steps S302 and S303 when the comparison in step S311 indicates that the sum of the amount of power generation of the first and second power generators and the amount of available power stored in the ESS is greater than the amount of electric power use of the plurality of electric power use devices. In this way, the electric power management device addresses the insufficient supply of electric power by utilizing the available amount of stored power in the ESS without operating the third power generator.

The electric power management device 200 controls the third power generator 130 to operate in step S312 when the comparison in step S311 indicates that the sum of the amount of power generation of the first power generator 110 and second power generator 120 and the available amount of power stored in the ESS 300 is less than the amount of electric power use of the plurality of electric power use devices 400. In this way, the electric power management device addresses the insufficient supply of electric power by utilizing power generated by operating the third power generator.

The electric power management device compares a sum of the amount of power generation of the first power generator 110, the second power generator 120 and the third power generator 130 to the amount of electric power use of the plurality of electric power use devices 400 in step S313. The electric power management device identifies an amount of available power stored in the ESS 300 in step S314 when the comparison of step S313 indicates that the sum of the amount of power generation of the first power generator, second power generator and third power generator is less than the amount of electric power use of the plurality of electric power use devices such as when there is a decrease in the amount of power generation of the first power generator, second power generator and third power generator or an increase in the amount of electric power use of the plurality of electric power use devices. The electric power management device calculates the amount of available stored power in the ESS by subtracting an amount of required emergency power from a total amount of power stored in the ESS.

The electric power management device 200 compares a sum of the amount of power generation of the first power generator 110, the second power generator 120 and third power generator 130 and the amount of available power stored in the ESS 300 to the amount of electric power use of the plurality of electric power use devices 400 in step S315. The electric power management device re-performs step S307 to supply the electric power stored in the ESS and then re-performs steps S302 and S303 when the comparison in step S315 indicates that the sum of the amount of power generation of the first, second and third power generators and the amount of available power stored in the ESS is greater than the amount of electric power use of the plurality of electric power use devices. In this way, the electric power management device addresses the insufficient supply of electric power by utilizing the available amount of stored power in the ESS without interrupting electric power to any of the electric power use devices.

The electric power management device 200 interrupts electric power supplied to the one or more plurality of electric power use devices 400 in ascending order of the predetermined priority in step S316 when the comparison in step S315 indicates that the sum of the amount of power generation of the first power generator 110, the second power generator 120 and the third power generator 130 and the available amount of power stored in the ESS 300 is less than the amount of electric power use of the plurality of electric power use devices. In this way, the electric power management device addresses the insufficient supply of electric power by interrupting power to one or more of the plurality of plurality of electric power use devices.

For example, the electric power management device 200 may interrupt electric power supplied to the third electric power use device 430 having the third priority as the lowest priority and re-perform step S313 to determine if sufficient power is available to meet current requirements. Thereafter, the electric power management device may interrupt electric power supplied to the second electric power use device 420 having the second priority when the electric power supply amount is determined as still insufficient in step S313.

The electric power management device 200 determines if electric power has been previously interrupted to one or more of the electric power use devices 400 in step S317 when the comparison in step S309 indicates that the sum of the amount of power generation of the first power generator 110 and second power generator 120 is greater than the amount of electric power use of the plurality of electric power use devices. The electric power management device then either restores power to one or more electric power use devices or controls the second power generator to stop operating.

The electric power management device 200 controls the second power generator 120 to stop operating in step S318 when it is determined in step S317 that there is no electric power use device 400 to which electric power is has been previously interrupted. The electric power management device then performs step 306 to determine if sufficient power is available to meet current requirements. In this way, the electric power management device may control only the first power generator 110 to be operated when the an excess amount electric power remains due to a decrease in the amount of electric power use of the plurality of electric power use devices.

The electric power management device 200 releases the interrupted power of one of more of the plurality of electric power use devices 400 in step S319 according to an ascending predetermined priority when it is it is determined in step S317 that electric power to one of more of the plurality of electric use devices has been previously interrupted. The power management device then re-performs step S309 to determine if sufficient power is still available to meet current requirements.

For example, the electric power management device 200 may release the interruption of electric power to the second electric power use device 420 having the highest priority among the electric power use devices to which electric power has been previously interrupted when electric power to the second electric power use device and third electric power use device 430 have been previously interrupted. Thereafter, the electric power management device 200 re-performs step S317 when it is determined in step S309 that an excess amount electric power supply still remains and may re-perform step S312 to restore the interrupted power to the third electric power use device 430 having the next highest priority.

The electric power management device 200 determines if electric power has been previously interrupted to one or more of the plurality of electric power use devices 400 in step S320 when the comparison in step S313 indicates that the sum of the amount of power generation of the first power generator 110, second power generator 120 and third power generator 130 is greater than the amount of electric power use of the plurality of electric power use devices 400. The electric power management device then either restores power to one or more electric power use devices or controls the third power generator to stop operating.

The electric power management device 200 controls the third power generator 130 to stop operating in step S321 when it is determined in step S320 that there is no electric power use device 400 to which electric power has been previously interrupted. The electric power management device then performs step S311 to determine if sufficient power is available to meet current requirements.

The electric power management device 200 releases the interrupted power of one of more of the plurality of electric power use devices 400 in step S322 according to an ascending predetermined priority when it is it is determined in step S320 that electric power to one of more of the plurality of electric use devices has been previously interrupted. The power management device then re-performs step S311 to determine if sufficient power is still available to meet current requirements.

The embodiments of the present invention facilitate improving production efficiency for a plurality of power generators by controlling the plurality of power generators to operated and stop operating in descending order of power generation efficiency and ascending order of power generation cost.

The embodiments of the present invention facilitate stable supply of electric power to electric power use devices having highest priority by interrupting electric power in ascending order of priority when a shortage of electric power occurs.

The embodiments of the present invention provide an advantageous effect that an emergency state, such as a power failure, is easily addressed because electric power may be supplied while a minimum storage amount necessary for emergency power is maintained in the ESS.

The invention has been described by reference to certain preferred embodiments. However, those skilled in the art should understand that it may be embodied in other specific forms or variations thereof without departing from its spirit or essential characteristics.

The described embodiments of the present invention are considered to be illustrative in all respects and not restrictive with the scope of the invention being indicated by the appended claims rather than by the description. For example, components which have been illustrated as being integrated with each other may be implemented in a separate structure and components which have been illustrated as being separately provided may be provided in an integrated structure. For example, the described embodiments may be applied to more or less than the described numbers of power generators, electric power management devices and electric use devices.

It is to be interpreted that all changes or modifications derived from the meaning, scope and equivalent concept of the appended claims are within the scope of the present invention.

What is claimed is:

1. A method of managing power devices, the method comprising:
operating a first power generator according to a predetermined operating plan;
determining an amount of available stored power by subtracting a required amount of emergency power from a total amount of power stored in an energy storage system (ESS) when an amount of generated power of the first power generator is less than an amount of power required by a plurality of power use devices;
operating a second power generator when a first sum of an amount of generated power of the first power generator and the determined amount of available stored power is less than the required amount of power; and
interrupting power provided to the at least one of the plurality of power use devices in ascending order of priority when a second sum of the amount of generated power of the first power generator and an amount of generated power of the second power generator is less than the required amount of power.

2. The method of claim 1, further comprising:
operating each of the first power generator, the second power generator, and a third power generator according to a corresponding determined power generation efficiency and determined power generation cost.

3. The method of claim 2, further comprising:
operating the third power generator when a third sum of the amount of generated power of the first power generator, the amount of generated power of the second power generator, and the determined amount of available stored power is less than the required amount of power.

4. The method of claim 3, further comprising:
stopping operation of the third power generator when the second sum is greater than the required amount of power.

5. The method of claim 1, further comprising:
predicting information related to at least weather, resource cost or power generation efficiency; and
revising the operating plan for each of a plurality of time zones according to the predicted information.

6. The method of claim 1, further comprising:
setting priorities of the plurality of power use devices according to a corresponding degree of importance and a corresponding degree of risk of power supply interruption.

7. The method of claim 1, further comprising:
storing excess power in the ESS when the amount of generated power of the first power generator is greater than the required amount of power.

8. The method of claim 1, further comprising:
supplying power stored in the ESS when the first sum is greater than the required amount of power.

9. The method of claim 1, further comprising:
identifying power use devices to which power has been previously interrupted when the second sum is greater than the required amount of power; and
releasing the interruption of power to at least one of the identified power use devices in descending order of priority.

10. The method of claim 9, further comprising:
stopping operation of the second power generator if no power use devices are identified to which power has been previously interrupted.

11. A power management system comprising:
a plurality of power generators configured to generate power;
an energy storage system (ESS) configured to store power;
a plurality of power use devices configured to use power;
an ESS control unit configured to determine an amount of available stored power by subtracting a required amount of emergency power from a total amount of power stored in the ESS;
a power generator operation control unit configured to:
operate a first power generator according to a predetermined operating plan;
determine that an amount of generated power of the first power generator is less than an amount of power required by a plurality of power use devices; and
operate a second power generator when a first sum of an amount of generated power of the first power generator and the determined amount of available stored power is less than the required amount of power; and
an electric power interruption control unit configured to interrupt power provided to at least one of the plurality of power use devices in ascending order of priority when a second sum of the amount of generated power of the first power generator and amount of generated power of the second power generator is less than the required amount of power use.

12. The system of claim 11, wherein the power generator operation control unit is further configured to operate each of the first power generator, the second power generator, and a third power generator according to a corresponding determined power generation efficiency and determined power generation cost.

13. The system of claim 12, wherein the power generator operation control unit is further configured to operate the third power generator when a third sum of the amount of generated power of the first power generator, the amount of generated power of the second power generator, and the determined amount of available stored power is less than the required amount of power.

14. The system of claim 13, wherein the power generator operation control unit is further configured to stop operation of the third power generator when the second sum is greater than the required amount of power.

15. The system of claim 11, further comprising:
an operating plan unit configured to:
predict information related to at least weather, resource cost or power generation efficiency; and
revise the operating plan for each of a plurality of time zones according to the predicted information.

16. The system of claim 11, wherein the electric power interruption control unit is further configured to set priorities of the plurality of power use devices according to a corresponding degree of importance and a corresponding degree of risk of power supply interruption.

17. The system of claim 11, wherein the ESS control unit is further configured to store excess power in the ESS when the amount of generated power of the first power generator is greater than the required amount of power.

18. The system of claim 11, wherein the ESS control unit is further configured to supply power stored in the ESS when the first sum is greater than the required amount of power.

19. The system of claim 11, wherein the electric power interruption control unit is further configured to:
identify devices to which power has been previously interrupted when the second sum is greater than the required amount of power use amount; and
release the interruption of power to at least one of the identified power use devices in descending order of priority.

20. The system of claim 19, wherein the power generator operation control unit is further configured to stop operation of the second power generator if no power use devices are identified to which power has been previously interrupted.
